(19) United States
(12) Patent Application Publication
(10) Pub. No.: US 2012/0026732 A1
(43) Pub. Date: Feb. 2, 2012

(54) LAMP

(75) Inventor: Christian Fricke, Dachau (DE)

(73) Assignee: OSRAM GESELLSCHAFT MIT BESCHRÄNKTER HAFTUNG, München (DE)

(21) Appl. No.: 13/146,246

(22) PCT Filed: Jan. 19, 2010
(86) PCT No.: PCT/EP2010/050582

§ 371 Date: Sep. 22, 2011

(30) Foreign Application Priority Data
Jan. 27, 2009 (DE) 10 2009 006 185.1

(51) Int. Cl. F21V 9/00; F21V 99/00; F21V 7/00; F21V 21/00

(52) U.S. Cl. 362/231; 362/235; 362/257; 362/296.01

(57) ABSTRACT

A lamp includes a bulb comprising at least a partially light-transmissive material, a lamp base for fitting the lamp in a socket and feeding electrical energy, an illuminant arranged in the bulb and designed at least for a directed emission of light, and a means operable by a user for aligning the illuminant to vary an emission direction of the light.

### RELATED APPLICATIONS

This is a §371 of International Application No. PCT/EP2010/050582, with an international filing date of Jan. 19, 2010 (WO 2010/086257, published Aug. 5, 2010), which is based on German Patent Application No. 10 2009 006 185.1, filed Jan. 27, 2009, the subject matter of which is incorporated by reference.

### TECHNICAL FIELD

This disclosure relates to a lamp and, in particular, to lamps having optoelectronic semiconductor components.

### BACKGROUND

Present day incandescent lamps are widespread and have attained a high repeated recognition value with the consumer with regard to their shape and simple manipulation. In particular, the shape of the incandescent lamp in turn conditions the shape and/or the design of lamp holders, luminaires and the like.

At the same time, the classic incandescent bulb in the form of a light-transmissive or milky glass bulb with an incandescent tungsten wire arranged therein has various disadvantages. Firstly, the efficiency of such an incandescent bulb compared, for example, with lamps based on optoelectronic semiconductor components is substantially lower, since a large portion of the energy fed is converted to heat. Consequently, owing to the high thermal conversion of conventional incandescent lamps there is an increased fire risk, and so their use is possible only in areas not endangered by fire. At the same time, as a rule incandescent bulbs emit their light uniformly in all directions. This can have the effect that a portion of the light remains unused when, for example, the requirement is for a directed light. This can be prevented by externally arranged reflectors, and a directed light emission can be produced, for example, for reading lamps or similar.

With a growing environmental conscientiousness and the desire for lower power consumption, the need now exists to provide lamps that, on the one hand, exhibit the familiar handling and the robustness of the incandescent bulbs customary hitherto and, on the other hand, avoid the abovementioned disadvantages.

### SUMMARY

I provide a lamp including a bulb including at least a partially light-transmissive material, a lamp base for fitting the lamp in a socket and feeding electrical energy, an illuminant arranged in the bulb and designed at least for a directed emission of light, and a means operable by a user for aligning the illuminant to vary an emission direction of the light.

I also provide a lamp including a bulb including at least a partially light-transmissive material, a lamp base that fits the lamp in a socket and feeds electrical energy, an illuminant arranged in the bulb and designed at least for a directed emission of light, and a control lever operable by a user that aligns the illuminant to vary an emission direction of the light, in which the illuminant includes a first light source and a reflector configured for directed emission of light output by the first light source, and the reflector is arranged rotatably about the light source, wherein the control lever is coupled to the reflector and the control lever can be displaced by a user to vary the emission direction of the light produced during operation of the lamp.

### BRIEF DESCRIPTION OF THE DRAWINGS

FIGS. 1A, 1B and 1C show cross-sectional illustrations of a lamp according to a first example.

FIGS. 2A, 2B and 2C show cross-sectional illustrations of a lamp according to a further example.

FIGS. 3A and 3B show sectional illustrations of a third example.

FIG. 4 shows a sectional illustration of a fourth example.

FIGS. 5A and 5B show sectional illustrations of a gear for a rotation of the illumination by a user.

FIG. 6 shows an illustration of a further gear for coupling the illuminant to the operating element.

FIGS. 7A and 7B show sectional illustrations of a further design for coupling the illuminant to the operating element.

### DETAILED DESCRIPTION

We provide a lamp that comprises a bulb made from a material that is at least partially light-transmissive. This bulb can be, for example, a transparent or milky glass bulb in the form of the incandescent bulbs known so far. For example, the bulb can be in the shape of a pear or drop. The lamp further has a lamp base for fitting the lamp in a socket. In addition, electrical energy for operating the lamp is fed via the lamp base. Also provided is an illuminant arranged in the bulb designed to emit light in a directed fashion. Finally, the lamp comprises a means operable by a user for aligning the illuminant inside the body to thus vary an emission direction of the light.

An illuminant arranged in the bulb is supported rotatably or pivotable. A rotation is performed via the means for aligning the illuminant, which is arranged outside in the vicinity of the lamp base or of the bulb, is operationally connected to the illuminant for the purpose of changing the position thereof, and is operable by a user.

The illuminant can comprise a light source and a reflector for this purpose.

The reflector can be configured for the directed emission of light output by the light source. Thus, the light source can be arranged in front of the reflector. In this context, it is therefore possible to arrange a standard light source in front of the reflector, the result being that a light output in the direction of the reflector by the standard light source, for example, a spiral-wound filament, is reflected thereby and emitted directionally. The emission direction of the light is varied by a rotation or a change in position of the reflector inside the bulb with the aid of the aligning means operable by the user.

In one design, the lamp is essentially arranged centrally in the glass bulb and connected there rigidly via a holder to the socket or the base for feeding electrical energy. The reflector is arranged on a ring supported such that it can rotate and/or tilt and through which the holder of the lamp projects. The ring is held by the base and the wall of the base. For this purpose, the inner wall of the base can be designed with a circumferential depression or a circumferential U-shaped bearing in which the ring lies. The ring is thereby rotatably supported. The means is connected to the ring such that a rotation of the means causes rotation of the ring and thus of the reflector.

The reflector can in this case comprise a reflecting surface, for example, a curved mirror, with a parabolic or quasi-parabolic shape.

In another example, the illuminant comprises at a first end at least a first light source for a directed emission, and at a second end, averted from the first end, at least a second light source for an undirected emission. In this context, the illuminant can comprise a fastening element on which the first and the second light source are fastened. The fastening element can also have a parabolic, round or quasi-parabolic shape. The light sources can be configured such that they follow this shape.

In that example, a background lighting is thereby achieved by the second light source in conjunction with a simultaneously output directed light beam by the first light source. The lamp therefore implements a background lighting and, simultaneously, a functional light.

During operation, the two light sources can preferably have a different color or a different color temperature. For example, the second light source, having an undirected emission characteristic, can have a lower color temperature, and can therefore evoke a “warmer” color impression for the user than does the first light source. It is also possible to use different colors for the first and for the second light source. The light sources can be designed as optoelectronic semiconductor bodies. They are supplied with energy via the fastening element which, for its part, is coupled to the corresponding control and supply electronics in the lamp base. It is expedient in this context when the fastening element also serves simultaneously as heat sink for the optoelectronic components.

The illuminant can be supported rotatably about an axis running in a substantially parallel fashion through the lamp base. In addition, the illuminant can comprise a joint in its lower region such that it is also supported such that it can swivel and/or tilt. This permits a user the ability both to rotate and to swivel the illuminant by using an externally fitted fastening element to thus produce the desired emission direction.

To this end, it is possible to provide in the lower region of the bulb a cutout through which there projects a control lever that is coupled to the reflector to produce a rotational movement. Alternatively, a joint can be used to achieve a coupling between the illuminant and the means operable by a user on the outside. The operable means can thus be in contact with the illuminant via a worm shaft. Other gears are likewise possible, for example, spiral gears or bevel gears. Depending on which gear or coupling is used, it is possible for the illuminant to be rotated about an axis running substantially parallel to the base, but a tilting or swiveling movement is also possible.

It is possible to design the glass bulb in a gastight fashion so that protective gas in the interior of the bulb serves for improved exchange of heat, and thus lengthens the service life of the lamp.

Our lamps are explained in more detail below with the aid of a plurality of examples and with reference to the drawings.

Components which are the same or act in the same way can be provided with the same reference numerals in the following examples and figures. The figures and the proportions of size, in particular also the proportions of size of individual subregions and elements one to another, are basically regarded as not true to scale. Rather, they serve to clarify individual aspects. To further better understanding or to improve the capacity for illustration, those aspects can be illustrated with an exaggerated size or thickness. Again, our lamps are not limited to the examples used to describe them. Rather, this disclosure comprises any new feature and any combination of features which includes, in particular, any combination of features in the appended claims, even if those features or their combination are not themselves specified explicitly in the claims or the examples.

The coupling, explained below, between the operating element for the user and the illuminant inside the lamp base can also be of different design. Possible, for example, are joints, rigid connections or similar couplings that permit a user to employ an external control lever or an external operating element to produce a turning movement, swiveling movement, rotation or other change in position of the illuminant proceeding in relation to the glass body.

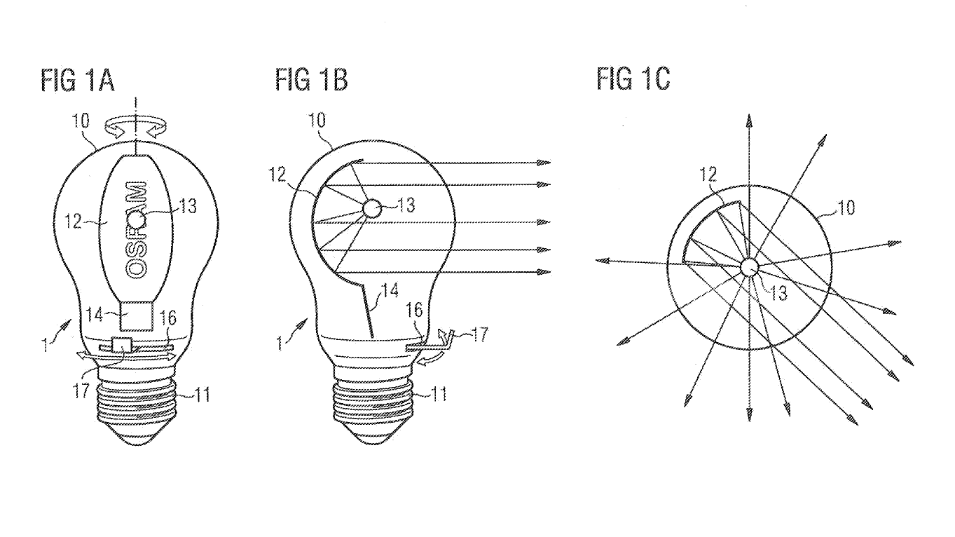

FIG. 1A shows a first sectional illustration of a lamp. This lamp is designed in the form of a known incandescent bulb. To this end, the lamp comprises a lamp base 11 which is designed in this case as an Edison base. Such bases are used, inter alia, in incandescent lamps of different design and with different diameters. In addition to an Edison lamp base as illustrated here, other bases are also possible, for example, plug-in bases, bayonet bases or glass bases.

In the present case the base is screwed, plugged or otherwise fitted into a socket and serves, in addition, to feed electrical energy to the light source 13 located inside the light-trans-missive glass body 10. In the present case, the light source 13 is merely indicated. In addition to optoelectronic semiconductor elements, as is further explained in more detail below, the light source can also include standard light sources, for example, in the form of halogen lamps or else incandescent filaments. There is an electrical connection between the light source 13 and the lamp base 11. The light source can be fitted inside the bulb independent of the reflector 12 additionally present. This permits the reflector 12 to vary its position independently of the light source 13, and so permits a change in the directed emission of the light to be achieved.

As illustrated in FIGS. 1A to 1C, the reflector 12 has an oval shape in the form of a partial segment. Its side facing the light source is mirrored, and lettering can be applied on its averted side. The reflector 12 is coupled to the externally arranged control lever 17 via the fastening element 14. The control lever reaches through a narrow opening 16 into the glass bulb and can be moved by the user from right to left, as illustrated. Consequently, the reflector rotates partially about an axis running through the lamp base 11, as is indicated by the arrow in the upper region of FIG. 1A. The reflector 12 and light source 13 together form the illuminant.

FIG. 1B shows a sectional view of this example. The reflector 12 is curved in this case such that the radiation output by the light source 13 is aligned in a substantially parallel fashion and output in the desired emission direction. The light that is, in turn, output by the light source 13 in other directions and not retroreflected by the reflector is denoted as undirected light. This is illustrated in the plan view of FIG. 1C. In the present case, the light source 13 therefore produces an undirected light component and also, using the reflector 12, a directed light component. The lamp can therefore be used both as background lighting in conjunction with a functional light.

The emission of the directed light is set to a certain extent by rotation of the reflector 12 about the light source 13. This allows the emission direction also to be changed, given an initially prescribed direction caused by screwing the lamp base into the corresponding socket.

As illustrated, the reflector can have a striking 3D shape and additionally include logos, imprints or other design elements.

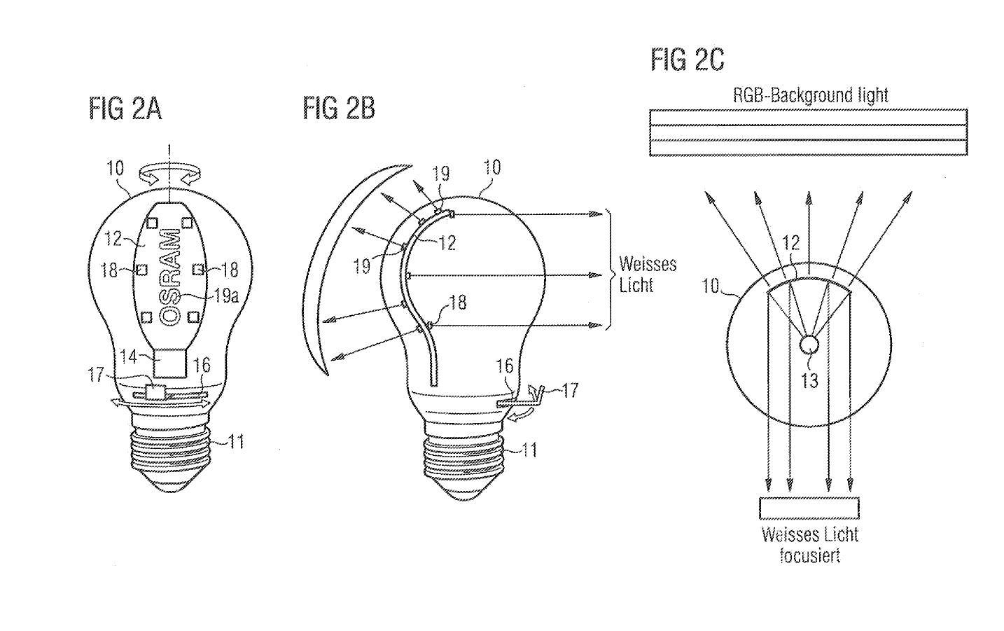

FIGS. 2A to 2C show a further example, in which the light sources are implemented by optoelectronic components. The optoelectronic components are light-emitting diodes that produce white light during operation. To this end, the optoelectronic components can comprise various semiconductor layers which respectively emit light of different wavelength. The desired white light is thus produced by suitable mixing. Alternatively, white light can also be implemented by an optoelectronic component on which a conversion layer is arranged. Gallium-arsenide-based III-V semiconductors, inter alia, are candidates for this purpose as optoelectronic components.

Also equally capable of use, however, are organic light-emitting diodes that, in addition, can be designed as relatively large surfaces. In one design, a planar organic light-emitting diode is output on the reflector and therefore follows the curvature prescribed by the reflector. Other 3-D shapes can also be implemented with an organic light-emitting diode.

FIG. 2A shows a relevant example in which the optoelectronic semiconductor components 18 are arranged on the reflector. The reflector further includes lettering “OSRAM,” which is to be seen only in the switched-off state of the lamp. In the switched-on state, in which the individual light-emitting diodes 18 emit white light in a directed fashion, the lettering is obscured by the emitted light. The reflector or the lettering can comprise a fluorescing material. The example thereby also has an afterglow in the switched-off state. It is thereby possible, for example, to simulate an attenuating light.

It is to be seen in the side view in accordance with FIG. 2B that optoelectronic components 19 are additionally applied to a second side of the reflector 12. However, the optoelectronic components do not have a directed emission characteristic, but produce light with an undirected emission characteristic. This is also called RGB light background. Another color or color temperature for the background light can be produced by the use of other components or components having different material systems.

Consequently, the lamp illustrated can be used to set a background lighting at a first color temperature or in a first color, while on the front side of the reflector the component 18 output light in a regulated fashion at another color temperature. The control lever 17 which is coupled to the reflector 12 can be displaced by a user along the slot 16 to vary the emission direction of the light-emitting diodes 18.

A control electronics (not illustrated here) inside the lamp base 11 supplies both the light-emitting diodes 18 on the front side of the reflector 16, and the light-emitting diodes 19 on the rear side. The control electronics can also be accommodated in the socket into which the lamp is inserted.

Alternatively, there is the option of using the control electronics to set a color temperature of the light-emitting diodes 19 or 18. Different color impressions for the background lighting and the functional light can thereby be implemented.

In addition to the directing function, the reflector 12 also serves to dissipate the heat produced during operation of the components 18 and 19. Its function therefore comprises both the guidance of light for the output of a directed light beam and the waste heat transfer. In addition, the glass bulb can be filled with a protective gas that permits good heat coupling to the reflector. Consequently, the reflector both dissipates heat via the lamp base, and via the protective gas outward onto the glass bulb 10.

In addition to this simple illustration of a reflector, for example in the form of a “spoon,” it is also possible to implement further three dimensional shapes inside the glass bulb 10 for such lamps.

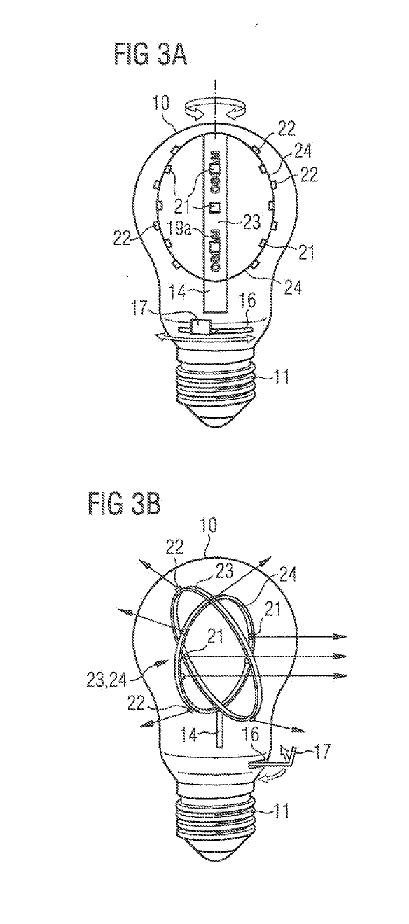

FIGS. 3A and 3B show such an example in various views.

In this example, the illuminant is formed by two oval spherical segments which stand one on top of the other. In addition to spherical segments, it is also possible to conceive of segments with rectangular or other shapes.

Both segments are supported rotatably about a holder 14. The two oval spherical segments respectively bear various optoelectronic components 21, 22 on the inside and outside thereof. The arrangement of the components 21 and 22 is selected in such a way that a group of components for the directed emission of light is embodied. The second group of optoelectronic components 22 serves, in turn, to produce an undirected background lighting. The light guiding function for the light of the component 21 is implemented by displacing the control lever 17, which is coupled to the LED carriers 14, 23 and 24.

In another design, one of the segments is coupled to the light sources 21 for aligning purposes via a fastening element 14 with the aid of the control lever 17. The other segment is, by contrast, fixed and not rotatable. In this example, the fixed one of the two spherical segments have optoelectronic components for producing the background light, while on the second spherical segment, which is movably supported, optoelectronic components are arranged for producing the directed light beam. The second spherical segment is now connected rotatably to the control lever for the guidance of light, while the first spherical segment is rigidly fastened relative to the glass bulb 10. Consequently, a movement of the control lever rotates the second spherical segment relative to the first spherical segment. The rigid spherical segment is preferably somewhat smaller so that the rotatably supported segment moves around the rigid spherical segment arranged inside the rotatably supported segment. Instead of the rigidly arranged second segment, it is also possible to use another element with another shape. In this case, the rotatably supported segment rotates partially around the element arranged inside the segment.

Once again in another design, at least one of the two segments can have a planar light source that follows the curvature of the segment. The lamp can be an organic light-emitting diode, for example.

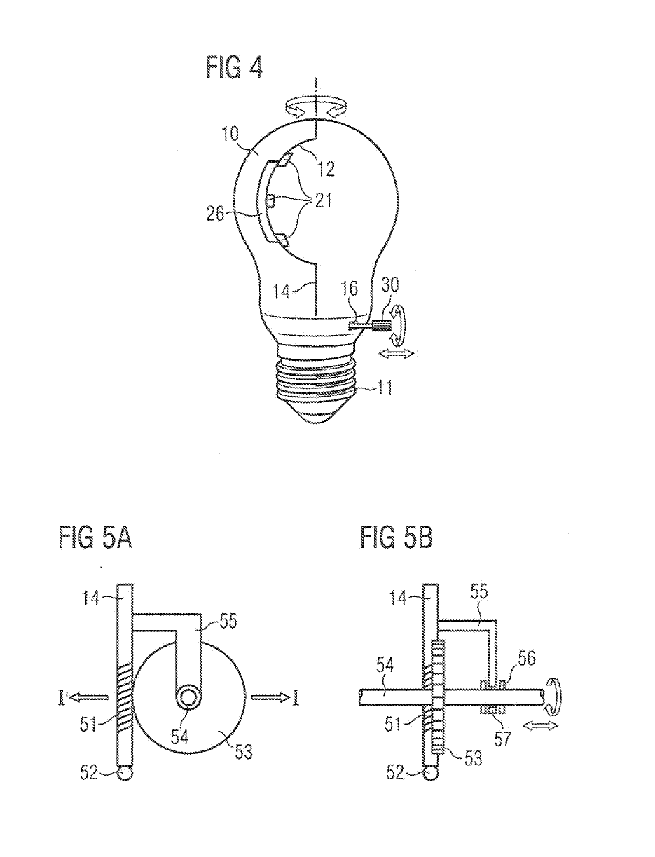

A further example is shown in FIG. 4. Arranged in a glass bulb 10 is the reflector 12 on whose first side a plurality of components 21 are arranged for outputting a directed light beam, while on the averted side a single relatively large light source 26 is arranged for producing the background light. In this example, the operating element 30 is connected to the reflector 12 and the reflector carrier 14 such that the reflector is likewise rotated by a rotation of the element 30 about its axis of rotation. Correspondingly, the reflector can be swiveled by pushing in the operating element 30 or by pulling out. The reflector can be positioned, and thereby an emission can be enabled in various spatial directions in this way.

FIG. 5 shows an example of a worm gear that is suitable for producing a rotation in the reflector or in the fastening element for the illuminant. In this case, a part of the fastening element 14 serves as a shaft that is provided with a plurality of threads 51. An obliquely toothed wheel, the worm gear 52, that meshes therein is guided toward the outside via a shaft 54 and thus forms a part of the operating element. The shaft 14 is connected to the lamp socket via an expandable element 52. The worm wheel 53 is rotated by a rotation of the operating element, and thus moves the shaft so that the reflector fastened thereon or the holding element for the light sources is rotated.

The cross-sectional view through the axis I′-I is illustrated in FIG. 5B. In addition to the yielding and expandable or compressible element 52, the shaft 14 is fastened once again on the operating element 54 via a bridge 55 and an annular rim 57. Two holders 56 on the operating element 54 serve for fixing the annular rim 57. As illustrated by the two arrows, the fastening element 14 is swiveled by displacement of the operating element along the axis x. Both a rotation of the fastening element 14, and a tilting of the element can be achieved in this way.

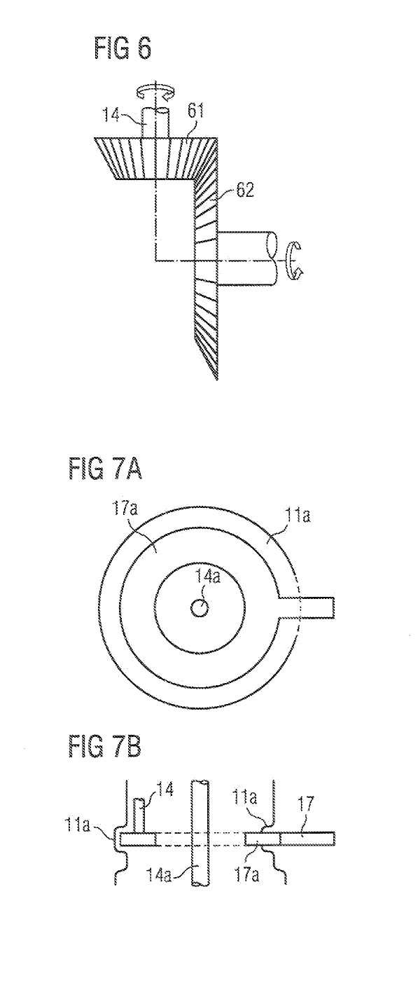

FIG. 6 shows a further example in the form of a bevel gear. An upper bevel gear 61 is rotatably arranged in this case on the fastening element 14. Via the angularly designed lateral surface, the shaft 61 is connected to a second shaft 62. The position of the fastening element 14 is likewise varied by rotating the second shaft 62 via the operating element.

Finally, FIGS. 7A and 7B show a ring in plan view and in a sectional illustration. The reflector 14 or the holder 14A for the illuminant is fastened on the ring 17A, which is rotatably supported in a U-shaped holder 11A of the base 11. The ring 17A is rotatably supported by the holder 11A. The ring 17A is connected to the control lever 17 through a cutout in the base.

In addition to the couplings, shown here, of the fastening element to the corresponding operating element on the user side, there is likewise the option of a rigid coupling without a gear engaged therebetween. This solution is, if appropriate, likewise expedient because of a simpler design. In addition to the rotatable reflector, it is possible to provide further beam guiding elements on the base or on the dome of the surrounding housing 10 to deflect in a targeted fashion light that falls thereon.

Functional light can be implemented and be freely set to a certain extent with regard to the position in relation to a background lighting by controlling the movable three-dimensional shape. A background lighting with a simultaneous functional light is implemented with the aid of the proposed principle, it being possible to produce different impressions for the user by selecting various color impressions and/or color temperatures.

1. A lamp comprising:
a bulb comprising at least a partially light-transmissive material;
a lamp base for fitting the lamp in a socket and feeding electrical energy;
an illuminant arranged in the bulb and designed at least for a directed emission of light; and
a means operable by a user for aligning the illuminant to vary an emission direction of the light.

2. The lamp according to claim 1, wherein the illuminant comprises a first light source and a reflector configured for directed emission of light output by the first light source.

3. The lamp according to claim 2, wherein the reflector is arranged rotatably about the light source.

4. The lamp according to claim 1, wherein the illuminant has at a first end at least the first light source for a directed emission, and at a second end, averted from the first end, at least a second light source for an undirected emission.

5. The lamp according to claim 4, wherein during operation the first light source has a color or color temperature that differs with respect to the second light source.

6. The lamp according to claim 1, wherein at least in a subregion the illuminant has a curved surface for a directed light emission.

7. The lamp according to claim 1, wherein the illuminant is rotatably supported about an axis running substantially parallel through the lamp base.

8. The lamp according to claim 1, wherein at least one light source of the first and of the second light source has a light-emitting semiconductor component or a light-emitting organic component.

9. The lamp according to claim 1, wherein the illuminant comprises at least one rotatably supported annular segment on whose surface at least one light source is arranged for a directed light emission.

10. The lamp according to claim 9, wherein the illuminant comprises at least one element on whose surface at least one light source is arranged for an undirected light emission.

11. The lamp according to claim 10, wherein the element is arranged inside the annular segment.

12. The lamp according to claim 1, wherein the means operable by the user is arranged in the region of the lamp base and is operationally connected to the illuminant in such a way that a movement of the means is converted to a rotational and/or tilt movement about an axis running through the lamp.

13. The lamp according to claim 1, wherein the lamp base comprises a holder for a rotatably supported ring connected to the means and to the illuminant.

14. The lamp according to claim 1, wherein the illuminant is coupled to the means via a joint arranged in the lamp base.

15. The lamp according to 1, further comprising a control device that outputs energy to the illuminant arranged in the lamp base.

16. A lamp comprising:
a bulb comprising at least a partially light-transmissive material;
a lamp base that fits the lamp in a socket and feeds electrical energy;
an illuminant arranged in the bulb and designed at least for a directed emission of light; and
a control lever operable by a user that aligns the illuminant to vary an emission direction of the light, in which
the illuminant comprises a first light source and a reflector configured for directed emission of light output by the first light source, and
the reflector is arranged rotatably about the light source, wherein the control lever is coupled to the reflector and the control lever can be displaced by a user to vary the emission direction of the light produced during operation of the lamp.
